(19) United States
(12) Patent Application Publication
(10) Pub. No.: US 2024/0221359 A1
(43) Pub. Date: Jul. 4, 2024

(54) IMAGE PROCESSING METHOD AND ELECTRONIC DEVICE

(71) Applicants: Lemon Inc., Grand Cayman (KY); Beijing Zitiao Network Technology Co., Ltd., Haidian District (CN)

(72) Inventors: Xiaojie Jin, Los Angeles, CA (US); Sen Pei, Beijing (CN)

(21) Appl. No.: 18/540,503

(22) Filed: Dec. 14, 2023

(30) Foreign Application Priority Data
Dec. 29, 2022 (CN) 202211713327.4

(51) Int. Cl. G06V 10/764; G06V 10/44

(52) U.S. Cl. CPC G06V 10/764; G06V 10/44

(57) ABSTRACT

The present disclosure provides an image processing method, an electronic device, and a computer-readable storage medium. The method comprises: obtaining an image feature corresponding to a first image, where the image feature comprises a domain feature and a class feature; performing a feature filtering processing on the domain feature in the image feature to obtain the class feature of the first image, where a relevance between the domain feature and an image classification of the first image is below a first threshold; and determining an image class of the first image according to the class feature.

### CROSS-REFERENCE TO RELATED APPLICATION

The present disclosure claims the priority of Chinese patent application CN202211713327.4, filed on Dec. 29, 2022 and entitled “IMAGE PROCESSING METHOD, APPARATUS, AND ELECTRONIC DEVICE”, the entire contents of which are incorporated herein by reference.

### FIELD

Embodiments of the present disclosure relate to the field of image processing technology, and more specifically, to an image processing method, an electronic device, and a computer-readable storage medium.

### BACKGROUND

Image classification technology may recognize images and further classify the images. For example, human face images, animal images or scenery images may be recognized through the image classification technology.

At present, the image may be classified through a trained image classification model. For example, the image classification model is trained based on a plurality of training samples, to learn different classes of image features and further implement the image classification.

### SUMMARY

The present disclosure provides an image processing method, an electronic device, and a computer-readable storage medium.

In a first aspect, the present disclosure provides an image processing method. The image processing method comprises: obtaining an image feature corresponding to a first image, the image feature includes a domain feature and a class feature; performing a feature filtering processing on the domain feature in the image feature to obtain the class feature of the first image, where a relevance between the domain feature and image classification of the first image is below a first threshold; and determining an image class of the first image according to the class feature.

In a second aspect, embodiments of the present disclosure provide an electronic device comprising: a processor and a memory; where the memory stores computer-executable instructions; the processor executes the computer-executable instructions stored in the memory, so as to perform the image processing method according to the above first aspect and various implementations of the above first aspect.

In a third aspect, embodiments of the present disclosure provide a computer-readable storage medium, where the computer-readable storage medium is stored with computer-executable instructions, the computer-executable instructions, when executed by a processor, implement the image processing method according to the above first aspect and various implementations of the above first aspect.

The present disclosure provides an image processing method, apparatus, and electronic device. The electronic device may obtain the image feature corresponding to a first image, where the image feature includes a domain feature and a class feature; perform a feature filtering processing on the domain feature in the image feature to obtain the class feature of the first image, where a relevance between the domain feature and image classification of the first image is below a first threshold; and determine an image class of the first image according to the class feature. In the above method, because the domain feature is less relevant with the image classification, the electronic device may filter out the domain feature in the image feature and keep the class feature relevant with the image classification. Even if the domain feature of the first image is a new feature, the electronic device also may accurately classify the first image according to the class feature of the first image, to further increase the accuracy of image classification.

### BRIEF DESCRIPTION OF THE DRAWINGS

Brief introduction of the drawings required in the following description of embodiments or the prior art are to be provided below to more clearly explain the technical solutions according to embodiments of the present disclosure or in the prior art. It is obvious that the following drawings illustrate some embodiments of the present disclosure and those skilled in the art also may obtain other drawings on the basis those illustrated ones without any exercises of inventive work.

FIG. 1 illustrates a schematic diagram of an application scenario of embodiments of the present disclosure;

FIG. 2 illustrates a flowchart of an image processing method provided by embodiments of the present disclosure;

FIG. 3 illustrates a schematic diagram of a procedure for determining the class feature provided by embodiments of the present disclosure;

FIG. 4 illustrates a schematic diagram of a procedure of the image processing method provided by embodiments of the present disclosure;

FIG. 5 illustrates a schematic diagram of method for training the first model provided by embodiments of the present disclosure;

FIG. 6 illustrates a schematic diagram of a sample first probability provided by embodiments of the present disclosure;

FIG. 7 illustrates a schematic diagram of a sample second probability provided by embodiments of the present disclosure;

FIG. 8 illustrates a structural diagram of an image processing apparatus provided by embodiments of the present disclosure;

FIG. 9 illustrates a structural diagram of a further image processing apparatus provided by embodiments of the present disclosure;

FIG. 10 illustrates a structural diagram of an electronic device provided by embodiments of the present disclosure.

### DETAILED DESCRIPTION OF EMBODIMENTS

Example embodiments are to be described in details below and the examples thereof are demonstrated in the drawings. In case that reference is made to the drawings in the following description, same number in different drawings represents same or similar elements unless indicated otherwise. Implementations described in the example embodiments below do not represent all implementations consistent with the present disclosure. On the contrary, the described implementations are just examples of apparatuses and methods that are elaborated in the attached claims and consistent with some aspects of the present disclosure.

For a better understanding of the present disclosure, concepts involved in embodiments of the present disclosure are explained below.

An electronic device is a device with wireless tranceiving function. The electronic device may be deployed on land, including indoor, outdoor, hand-held, wearable or vehicle-mounted devices. The electronic device may be mobile phone, Pad, computer with wireless transceiving function, Virtual Reality (VR) electronic device, Augmented Reality (AR) electronic device, wireless terminal in industrial control, onboard electronic device, wireless terminal in self driving, wireless electronic device in remote medical treatment, wireless electronic device in smart grid, wireless electronic device in transport safety, wireless electronic device in smart city, wireless electronic device in smart home, and wearable electronic device etc. The electronic device involved in embodiments of the present disclosure also may be referred to as terminal, user equipment (UE), access electronic device, onboard terminal, industrial control terminal, UE unit, UE station, mobile station, remote station, remote electronic device, mobile device, UE electronic device, wireless communication device, UE proxy, or UE apparatus etc. The electronic device may be fixed or mobile.

Class of image indicates a class of an object in the image. For example, if the object in the image is cat, the image is in cat class; if the object in the image is dog, the image is in dog class; if the object in the image is a human face, the image is in human face class. It is to be explained that the class of the image may be determined by any image classification methods, which are not limited in embodiments of the present disclosure.

Domain information of the image is information irrelevant to the image class. For example, in terms of a human face image, the information related to the image classification may include human face information and the information irrelevant to the image classification may include an image style. As such, the domain information of the image may include the style information of the image. For example, for a human face image, the style of the human face image may be photo, sketch or oil painting etc. However, the style of the human face image has no influence on its classification despite the style is photo, sketch or oil painting. The photo of the human face image, the sketch of the human face image, and the oil painting of the human face image are images of the same class (same type), yet in different domains (different styles).

In the related technology, the electronic device may classify the image through a trained image classification model. For example, in case that the image classification model is a human face recognition model, the human face recognition model may recognize an image including the human face; if the image classification model is an animal recognition model, the animal recognition model may recognize an image including an animal. The image classification model may learn a plurality of sample images in a training set to fulfill the image classification function.

However, during training, the image classification model would learn information (e.g., image style etc.) in the training samples irrelevant to the image classification. If the information irrelevant to the image classification in the image to be classified is not learnt by the image classification model, the image classification model could not accurately classify the image to be classified. As a result, the accuracy for image classification is relatively low. Specifically, the sample images also include domain information irrelevant to the image classification. While learning the sample images, the image classification model would also learn the domain information in the sample images. The scope of the domain information however is relatively broad (i.e., labels of the domain information could not be created satisfactorily). In case that the image includes the domain information not learned by the image classification model, it is impossible for the image classification model to accurately classify the image. For example, the human face image learned by the image classification model has an image style of photo; in such case, if a new human face image has an image style of sketch, the image classification model could not recognize the human face image in sketch style. Therefore, the image recognition is low in accuracy.

To address the above technical problem, embodiments of the present disclosure provide an image processing method. The electronic device may obtain a first image and obtain an image feature corresponding to the first image, the image feature including a domain feature and a class feature. The first image is processed according to a first model to obtain a corresponding domain feature of the first image; the domain feature is subtracted from the image feature to obtain the class feature of the first image. The electronic device determines an image class of the first image according to the class feature. Accordingly, due to the low relevance of the domain feature to the image class of the first image, the electronic device may filter out the domain feature in the image feature and maintain the class feature related to the image classification. Even if the domain information of the first image is new, the electronic device also may accurately classify the first image according to the class feature of the first image. The image classification therefore becomes more accurate, and thus the technical problem of low accuracy of image classification in the prior art may be addressed.

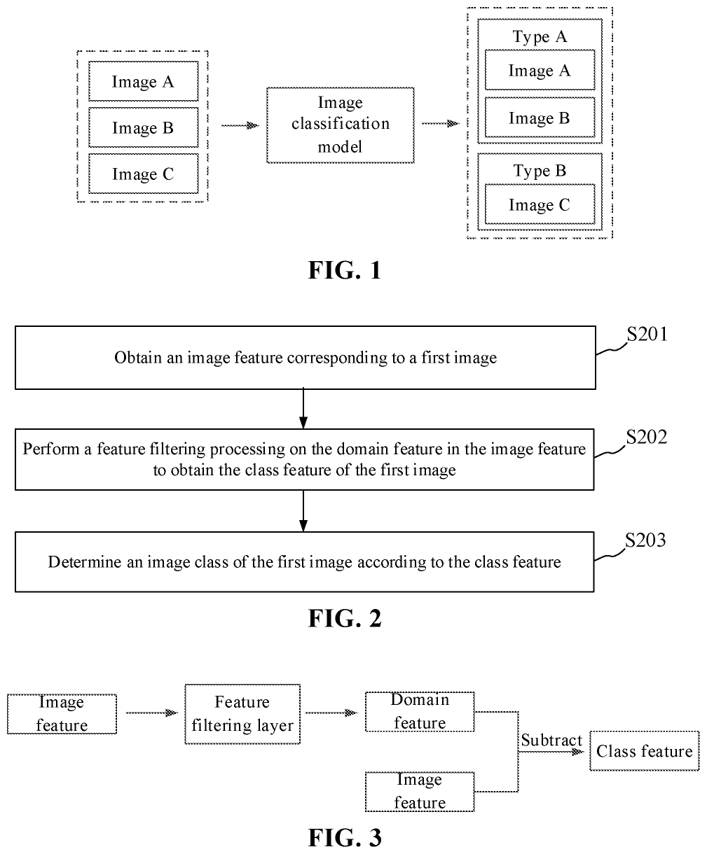

With reference to FIG. 1, an application scenario of embodiments of the present disclosure are explained below.

FIG. 1 illustrates a schematic diagram of the application scenario for embodiments of the present disclosure. FIG. 1 includes the image classification model and images A, B and C, where the image classification model may classify the images. After the images A, B and C are input to the image classification model, the image classification model may obtain the image feature corresponding to each image and filter the domain feature in the image feature, to obtain the class feature of the image A, the class feature of the image B and the class feature of the image C. The image classification model may classify the image A and the image B to Type A based on the class features of the images A and B, and classify the image C to Type B based on the class feature of the image C. Accordingly, the image classification model may filter out the domain feature irrelevant to the image classification in the image feature and keep the class feature related to the image classification. Consequently, the accuracy of image classification is improved thereby.

It is to be explained that FIG. 1 only demonstrates one application scenario of embodiments of the present disclosure by way of examples, rather than restricting the application scenario of embodiments of the present disclosure.

The technical solution of the present disclosure and how the technical solution of the present disclosure solves the above technical problem are to be described in details below with reference to the specific embodiments. The following specific embodiments may be combined with each other, and the same or similar concepts or procedures may not be repeated in some embodiments. Embodiments of the present disclosure are to be described below with reference to the drawings.

FIG. 2 illustrates a flowchart of an image processing method provided by embodiments of the present disclosure. With reference to FIG. 2, the method may include:

S201: an image feature corresponding to a first image is obtained.

The executive subject of embodiments of the present disclosure may be an electronic device, or an image processing apparatus disposed in the electronic device. Optionally, the image processing apparatus may be implemented by software or a combination of software and hardware, and embodiments of the present disclosure do not limit in this regard.

Optionally, the first image may be an image to be classified. For example, the first image may be an image in an image set, where the image set may include a plurality of types of images. The electronic device is required to classify the plurality of types of images in the image set. For example, if the electronic device can recognize a human face image, the first image may be the human face image; if the electronic device can recognize an animal image, the first image may be the animal image; if the electronic device may recognize a plant image, the first image may be the plant image. It is to be explained that the first image also may be an image that cannot be recognized by the electronic device, and embodiments of the present disclosure do not limit in this regard.

Optionally, the image feature may be an image feature of the first image, where the image feature is used to indicate image information in the first image and the image feature includes a domain feature and a class feature, where the domain feature has a low relevance with the image classification and the class feature has a high relevance with the image classification. For example, the image feature may be a feature map corresponding to the first image and the feature map may be a tensor.

Optionally, the electronic device may obtain the image feature of the first image by a neural network. For example, the electronic device may process the first image through a feature extraction network, to obtain the image feature of the first image. It is to be appreciated that the electronic device also may obtain the image feature of the first image through other ways, and embodiments of the present disclosure do not limit in this regard.

S202: a feature filtering processing is performed on the domain feature in the image feature to obtain the class feature of the first image.

Optionally, the domain feature may be a feature corresponding to domain information of the first image, and a relevance of the domain feature to the image classification of the first image is smaller than a first threshold. For example, in practical applications, the relevance of the domain feature of the first image to the image classification of the first image is relatively low, thus, image information indicated by the domain feature has less influence on the classification result of the first image. For example, since the image style in the human face image would not affect the type of the human face image (i.e., the photo of the human face image and the sketch of the human face image both belong to the type of human face image), the feature vector corresponding to the image style may be the domain feature of the first image. It is to be appreciated that the domain feature also may be other features having a low relevance to the image classification, and embodiments of the present disclosure do not limit in this regard.

Optionally, a relevance of the class feature to the image classification of the first image is greater than a second threshold. For example, during practical applications, the class feature of the first image is highly relevant with the image classification of the first image. As such, the image information indicated by the class feature has a great influence on the classification result of the first image. For example, if the first image A includes human face information, the human face information may affect the class of the first image; if the first image B contains plant information, the plant information may affect the class of the first image, i.e., the human face information determines the class of the first image A as image in human face class and the animal information determines the class of the first image B as image in animal class. Accordingly, the feature vector corresponding to the human face information may be the class feature of the first image A and the feature vector corresponding to the animal information may be the class feature of the first image B.

It is to be appreciated that the second threshold is greater than the first threshold. For example, the second threshold may be 90% and the first threshold may be 1%. Accordingly, the relevance of the domain feature obtained by the electronic device to the image classification is 1% and the relevance of the class feature obtained by the electronic device to the image classification is 90%.

Optionally, the electronic device may perform a filtering processing on the domain feature in the image feature to obtain the class feature of the first image through the following feasible implementations: processing the image feature according to a feature filtering layer in the first model to obtain a corresponding domain feature of the first image; and subtracting the domain feature from the image feature to obtain the class feature of the first image. Optionally, the feature filtering layer is used for obtaining the domain feature in the image feature. For example, the feature filtering layer may process the image feature, and thereby obtain the domain feature in the image feature.

Optionally, the first model is a model trained according to a plurality of groups of samples, where the plurality of groups of samples includes sample images and sample classes corresponding to the sample images. Optionally, the first model may include the feature filtering layer and a first classifier. Optionally, during the training process of the first model, the parameters in the feature filtering layer and in the first classifier are updated through the output of the first classifier, and the parameters in the second classifier are updated through the class feature and the sample class. For example, the feature filtering layer in the first model may obtain the domain feature in the image feature; the class feature of the first image may be obtained through the image feature and the domain feature; the domain feature and the class feature are processed through the first classifier to determine a loss of the feature filtering layer and the first classifier, so as to update the parameters in the feature filtering layer and the first classifier.

Optionally, the first model also includes the second classifier. Optionally, the second classifier may process the class feature to further determine the class image of the first image. For example, after determining the class feature of the sample image, the first model may update the parameters in the second classifier according to the class feature and the sample class (label) of the sample image. Subsequent to the convergence of the second classifier, the image class of the first image may be obtained through the second classifier.

With reference to FIG. 3, the procedure of determining the class feature is to be explained below.

FIG. 3 illustrates a schematic diagram of a procedure of determining the class feature provided by embodiments of the present disclosure. Referring to FIG. 3, the feature filtering layer is provided. The image feature of the first image is input to the feature filtering layer, and the feature filtering layer may process the image feature to obtain the domain feature of the first image. By subtracting the domain feature from the image feature, the class feature of the first image is obtained. Accordingly, the first model may classify the first image according to the class feature of the first image to increase the accuracy of image classification.

It is to be appreciated that since the first classifier may assist the first model in training, the first classifier may be kept during the training of the first model and further canceled during the use of the first model, and embodiments of the present disclosure do not limit in this regard.

S203: the image class of the first image is determined according to the class feature.

Optionally, the electronic device may process the class feature according to the second classifier in the first model, thereby obtain the image class of the first image. For example, after obtaining the class feature of the first image according to the feature filtering layer, the first model may input the class feature to the second classifier, and the second classifier may determine the image class of the first image according to the class feature.

Embodiments of the present disclosure provide an image processing method. The electronic device may obtain the image feature corresponding to the first image; process the first image according to the first model to obtain the corresponding domain feature of the first image; and subtract the domain feature from the image feature to obtain the class feature of the first image. The electronic device determines the image class of the first image according to the class feature. Therefore, because the domain feature is less relevant with the image classification of the first image, the electronic device may filter out the domain feature in the image feature and keep the class feature relevant with the image classification. Even if the domain information of the first image is new domain information, the electronic device also may accurately classify the first image according to the class feature of the first image, thereby increase the accuracy of image classification.

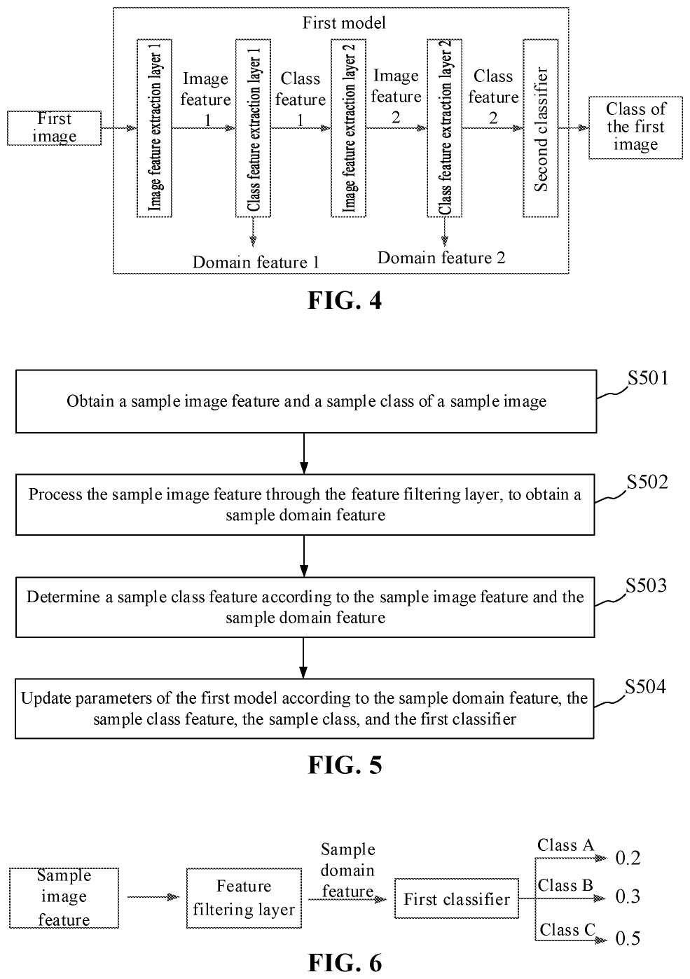

On the basis of embodiments shown by FIG. 2, the procedure of the above image processing method is explained below with reference to FIG. 4.

FIG. 4 illustrates a flowchart of the image processing method provided by embodiments of the present disclosure. Referring to FIG. 4, the first image and the first model are included. The first model includes an image feature extraction layer 1, an image feature extraction layer 2, a class feature extraction layer 1, a class feature extraction layer 2 and a second classifier. The class feature extraction layers fulfill the functions demonstrated by the embodiment of FIG. 3 and the feature extraction layers are used for extracting features.

With reference to FIG. 4, when the first image is input to the first model, the image feature extraction layer 1 may perform feature extraction processing on the first image to obtain the image feature 1, which image feature 1 is passed to the class feature extraction layer. The class feature extraction layer 1 may filter the image feature 1 to remove the domain feature 1 in the image feature 1, and obtain the class feature 1. The class feature 1 is passed to the image feature extraction layer 2.

With reference to FIG. 4, the image feature extraction layer 2 may process the class feature 1 to obtain the image feature 2 (the image feature 2 is a feature resulted from a convolution of the class feature 1). The image feature 2 is passed to the class feature extraction layer 2, which class feature extraction layer 2 removes the domain feature 2 in the image feature 2, to obtain the class feature 2. The class feature 2 is passed to the second classifier.

With reference to FIG. 4, after the two filtering processes of the domain feature, the information indicated by the class feature 2 has a high relevance to a classification of the first image, and the second classifier may classify the first image according to the class feature 2, to further obtain the class of the first image. As such, the electronic device may keep the class feature associated with the image classification and accurately classify the first image according to the class feature of the first image. The accuracy of the image classification is therefore improved.

It is to be appreciated that the structure of the first model in the embodiment shown in FIG. 4 may be different. For example, the first model may include 1, 3 or 5 class feature extraction layers, and embodiments of the present disclosure do not limit in this regard.

On the basis of any one of the above embodiments, the above image processing method further includes a training process of the first model. The method for training the first model is to be explained below with reference to FIG. 5.

FIG. 5 illustrates a schematic diagram of a method for training the first model provided by embodiments of the present disclosure. With reference to FIG. 5, the method flow includes:

S501: a sample image feature and a sample class of a sample image are obtained.

Optionally, the sample image may be any image. For example, the sample image may be a human face image, an animal image, or a plant image etc. The sample image is not restricted in embodiments of the present disclosure. Optionally, the electronic device may obtain the sample image in a network. For example, the electronic device may obtain more sample images in the network and also may obtain the sample image through other ways. Embodiments of the present disclosure do not limit in this regard.

Optionally, the procedure of obtaining the sample image feature by the electronic device according to the sample image is identical to the procedure of obtaining the image feature of the first image by the electronic device in step S201, and embodiments of the present disclosure will not be repeated herein.

Optionally, the sample class may be a corresponding class of the sample image. For example, if the sample image is the human face image, the sample class corresponding to the sample image may be a class of human face; if the sample image is the animal image, the sample class corresponding to the sample image may be a class of animal; if the sample image is the plant image, the sample class corresponding to the sample image may be a class of plant.

It is to be appreciated that the scope of the sample class may be restricted according to the function of the first model. For example, if the first model is a human face recognition model, the sample class may include human face type image and non-human face type image; if the first model can recognize the human face image, the cat image and the dog image, the sample class may include image in the class of the human face, image in the class of cat, image in the class of dog and image in unrecognized class. The scope of the sample class may be randomly defined and embodiments of the present disclosure do not limit in this regard.

S502: the sample image feature is processed through the feature filtering layer to obtain a sample domain feature.

Optionally, the electronic device processes the sample image feature via the feature filtering layer in the first model to obtain the sample domain feature in the sample image feature. For example, the feature filtering layer may be a layer of neural network, through which layer of neural network part of the sample image feature may be filtered. This part of feature is further determined as sample domain feature. During the training of the model, the parameters of the feature filtering layer are updated, such that the feature filtering layer may accurately filter out the sample domain features irrelevant to the image classification in the sample image feature.

S503: the sample class feature is determined according to the sample image feature and the sample domain feature.

Optionally, the electronic device may determine a difference value between the sample image feature and the sample domain feature as the sample class feature. For example, during actual applications, both the sample image feature and the sample domain feature may be a feature graph of tensor. As such, the sample domain feature may be subtracted from the sample image feature. The sample domain feature is less relevant with the image classification, so the remaining feature in the sample image feature after the subtraction of the sample domain feature has a high relevance to the image classification. The remaining feature is thereby determined as the sample class feature corresponding to the sample image.

S504: parameters of the first model are updated according to the sample domain feature, the sample class feature, the sample class, and the first classifier.

Optionally, the electronic device may update the parameters of the first model through the following feasible implementations: processing the sample domain feature by the first classifier to obtain a plurality of sample first probabilities that the sample image indicated by the sample domain feature belongs to a plurality of preset classes; processing the sample class feature by the first classifier to obtain a plurality of sample second probabilities that the sample image indicated by the sample class feature belongs to the plurality of preset classes; and updating parameters in the feature filtering layer and the first classifier according to the plurality of sample first probabilities and the plurality of sample second probabilities.

Optionally, the preset class may be a class that the first model can classify. For example, if the first model can recognize images in the class of human face, images in the class of animal and images in the class of plant, the preset class may include a human face class, an animal class and a plant class. For example, if the first model can recognize 10 classes of images, the preset class also includes 10 classes.

Optionally, the sample first probability indicates a probability that the sample image corresponding to the sample domain feature belongs to a preset class. For example, if the first classifier can classify three classes of images, the first classifier may output the sample first probability that the sample image belongs to each class after processing the domain feature of the sample image.

Next, the sample first probability is to be explained below with reference to FIG. 6.

FIG. 6 illustrates a schematic diagram of a sample first probability provided by embodiments of the present disclosure. FIG. 6 demonstrates the sample image feature corresponding to the sample image, the feature filtering layer, and the first classifier, wherein the first classifier can recognize Class A, Class B, and Class C. The sample image feature is input to the feature filtering layer, and the feature filtering layer may obtain the sample domain feature in the sample image feature and input the sample domain feature to the first classifier. The first classifier may output, based on the sample domain feature, the sample first probability that the sample image belongs to three classes, wherein the sample first probability of the sample image belonging to the Class A is 0.2, the sample first probability of the sample image belonging to the Class B is 0.3, and the sample first probability of the sample image belonging to the Class C is 0.5.

It is to be appreciated that during the training process, since the domain feature is irrelevant with the image classification, the objective of the training is that a plurality of sample first probabilities resulted from processing the sample domain feature by the first classifier is a uniform distribution probability, that is, the first classifier could not classify the sample image according to the sample domain feature.

Optionally, the sample second probability indicates a probability that the sample image corresponding to the sample class feature belongs to a preset class. For example, if the first classifier can classify three classes of images, the first classifier may output the sample second probability that the sample image belongs to each class after processing the sample class of the sample image.

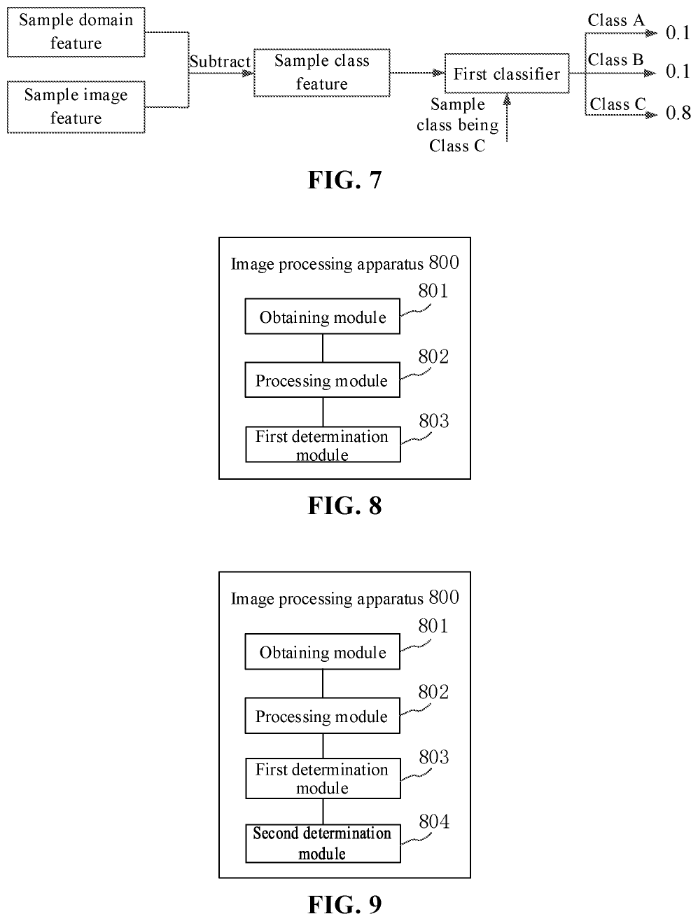

The sample second probability is to be explained below with reference to FIG. 7.

FIG. 7 illustrates a schematic diagram of a sample second probability provided by embodiments of the present disclosure. FIG. 7 demonstrates the sample domain feature, the sample image feature corresponding to the sample image, and the first classifier. The sample class feature is obtained by subtracting the sample domain feature from the sample image feature. The sample class feature and a label indicating the sample class as Class C are input to the first classifier, and the first classifier may output, according to the sample class feature, the sample second probability that the sample image belongs to three classes, wherein the sample second probability of the sample image belonging to the Class A is 0.1, the sample second probability of the sample image belonging to the Class B is 0.1, and the sample second probability of the sample image belonging to the Class C is 0.8.

It is to be appreciated that during the training process, since the class feature is relevant with the image classification, the objective of the training is that among a plurality of sample second probabilities resulted from processing the sample class feature by the first classifier, the sample class corresponds to a probability of 1 and the probability for the rest is 0, that is, the first classifier can accurately classify the sample image according to the sample class feature.

Optionally, updating, by the electronic device, parameters in the feature filtering layer and the first classifier according to the plurality of sample first probabilities and the plurality of sample second probabilities includes: obtaining a first distribution probability. Optionally, the first distribution probability may be a uniform distribution probability. For example, if the first classifier may classify ten types of images, the first distribution probability may include ten classes and the probability of each class is 0.1.

Optionally, a first loss is determined according to the plurality of sample first probabilities and the first distribution probability. For example, in case that the first distribution probability is [0.3, 0.3, 0.4] and the three sample first probabilities are [0.1, 0.6, 0.3], the first loss may be a cross entropy of the first distribution probability and the three sample first probabilities. It is to be appreciated that in embodiments of the present disclosure, since the sample domain feature is less relevant with the classification of the sample image, it is required that a plurality of sample first probabilities output by the first classifier is close to the first distribution probability. Accordingly, during the training procedure of the feature filtering layer, the relevance of the sample domain feature output by the feature filtering layer to the sample image classification may decrease and the accuracy of the domain feature is thereby improved.

Optionally, to further increase the accuracy for filtering the sample image feature by the feature filtering layer, Mahalanobis distance may serve as regular term constraint in the training procedure. For example, if the distribution of the sample image feature in every sample class is multivariate Gaussian distribution, the electronic device may determine distribution mean and covariance for each sample class, so as to obtain the Mahalanobis distance from each sample image to the sample center. Among the sample class features, the Mahalanobis distance from the sample class features in the same class (e.g., being human face images) to the feature center is smaller than the Mahalanobis distance from the sample image features in the same class among the sample image features to the sample center, that is, the feature filtering layer is required to reduce discrete degree of the sample class feature distribution, so as to decrease the distance between the sample class features in the same class.

Optionally, a second loss is determined according to the plurality of sample second probabilities and the sample class. Optionally, the electronic device may determine the second loss through the following feasible implementations: determining a second distribution probability according to the sample class. Optionally, a probability of a preset class identical to the sample class corresponds to a maximum probability in the second distribution probability. For example, during the training procedure of the first model, after the sample class feature corresponding to the sample image is obtained, the image class of the sample image corresponding to the sample class feature is already determined (label thereof is determined), therefore, the probability corresponding to the image class in the second distribution probability is set to 1 and the corresponding probability of other image classes is set to 0, thereby obtaining the second distribution probability. For example, the first classifier may classify the human face image and the animal image; in case that the sample class corresponding to the sample image is the image in the class of human face, the second distribution probability may be [1, 0], where the class having the probability of 1 is the image in the class of human face.

Optionally, the second loss is determined according to the plurality of sample second probabilities and the sample class. For example, if the second distribution probability is [1, 0, 0] and the three sample second probabilities are [0.5, 0.3, 0.2], then the second loss may be a cross entropy of the second distribution probability and the three sample second probabilities. It is to be appreciated that in embodiments of the present disclosure, since the sample class feature is highly relevant with the classification of the sample image, it is required that a plurality of sample second probabilities output by the first classifier is close to the second distribution probability. Accordingly, during the training of the first classifier, the relevance of the sample class output by the first classifier to the sample image classification may increase and the accuracy of the sample class feature is further improved.

Optionally, after determining the first loss and the second loss, the electronic device may update the parameters in the feature filtering layer and the first classifier according to the first loss and the second loss, and further train the feature filtering layer and the first classifier in the first model. After the training converges, the first classifier may be canceled. The feature filtering layer may be kept during the actual applications of the first model, and the class feature corresponding to the first image may be obtained through the feature filtering layer and the image feature, so as to determine the image class of the first image according to the class feature.

Optionally, the first model further includes the second classifier. After the training of the feature filtering layer and the first classifier in the first model is completed, the above method further includes: determining a third loss according to the sample class feature and the sample class; and updating parameters of the second classifier according to the third loss. For example, after the sample class feature of the sample image is obtained through the feature filtering layer, the sample class of the sample image corresponding to the sample class feature has been determined. Therefore, the sample class feature may be processed by the second classifier to obtain a predicted sample class. The third loss is further determined according to the predicted sample class and the sample class, and the second classifier in the first model is trained based on the third loss.

It is to be appreciated that the first loss, the second loss, and the third loss may collectively train the first model and embodiments of the present disclosure do not limit in this regard.

Embodiments of the present disclosure provide a method for training the first model, comprising obtaining a sample image feature and a sample class of a sample image; processing the sample image feature through the feature filtering layer to obtain a sample domain feature; determining a sample class feature according to the sample image feature and the sample domain feature; updating parameters of the first model according to the sample domain feature, the sample class feature, the sample class, and the first classifier. Accordingly, during the training procedure of the first model, the parameters in the feature filtering layer may be updated through the first classifier that assists the training, such that the relevance of the domain feature output by the feature filtering layer with the image classification is relatively low and the accuracy of the class feature is thereby improved. The first model may determine the image class of the first image based on the class feature of the first image. Therefore, even if the domain information of the first image is new domain information, the electronic device also may accurately classify the image and the accuracy of image classification is thereby improved.

FIG. 8 illustrates a structural diagram of an image processing apparatus provided by embodiments of the present disclosure. Referring to FIG. 8, the image processing apparatus 800 includes an obtaining module 801, a processing module 802, and a first determination module 803, wherein:

The obtaining module 801 is configured to obtain an image feature corresponding to a first image, where the image feature includes a domain feature and a class feature. The processing module 802 is configured to perform a feature filtering processing on the domain feature in the image feature to obtain the class feature of the first image, where a relevance between the domain feature and an image classification of the first image is below a first threshold. The first determination module 803 is configured to determine an image class of the first image according to the class feature.

In accordance with one or more embodiments of the present disclosure, the processing module 802 is specifically configured to: process the image feature according to a feature filtering layer in a first model to obtain a corresponding domain feature of the first image, the feature filtering layer is configured to obtain the domain feature in the image feature; and subtract the domain feature from the image feature to obtain the class feature of the first image; where the first model is a model trained according to a plurality of groups of samples, where the plurality of groups of samples include sample images and sample classes corresponding to the sample images.

The image processing apparatus according to embodiments of the present disclosure may be used for implementing the technical solution of the above method embodiments. The implementation principle and the technical effects of the apparatus are similar to the method and will not be repeated herein.

FIG. 9 illustrates a structural diagram of a further image processing apparatus provided by embodiments of the present disclosure. on the basis of embodiments shown in FIG. 8, referring to FIG. 9, the image processing apparatus further includes a second determination module 804, where the second determination module 804 is configured to: obtain a sample image feature and a sample class of the sample image; process the sample image feature through the feature filtering layer to obtain a sample domain feature; determine a sample class feature according to the sample image feature and the sample domain feature; and update parameters of the first model according to the sample domain feature, the sample class feature, the sample class, and the first classifier.

In accordance with one or more embodiments of the present disclosure, the second determination module 804 is specifically configured to: process the sample domain feature by the first classifier to obtain a plurality of sample first probabilities that the sample image indicated by the sample domain feature belongs to a plurality of preset classes; process the sample class feature by the first classifier to obtain a plurality of sample second probabilities that the sample image indicated by the sample class feature belongs to the plurality of preset classes; and update parameters in the feature filtering layer and the first classifier according to the plurality of sample first probabilities and the plurality of sample second probabilities.

In accordance with one or more embodiments of the present disclosure, the second determination module 804 is specifically configured to: obtain a first distribution probability, the first distribution probability is a uniform distribution probability; determine a first loss according to the plurality of sample first probabilities and the first distribution probability; determine a second loss according to the plurality of sample second probabilities and the sample class; and update the parameters in the feature filtering layer and the first classifier according to the first loss and the second loss.

In accordance with one or more embodiments of the present disclosure, the second determination module 804 is specifically configured to: determine a second distribution probability according to the sample class, where a probability of a preset class identical to the sample class corresponds to a maximum probability in the second distribution probability; and determine the second loss according to the plurality of sample second probabilities and the second distribution probability.

In accordance with one or more embodiments of the present disclosure, the second determination module 804 is specifically configured to: determine a third loss according to the sample class feature and the sample class; and update parameters of the second classifier according to the third loss.

The image processing apparatus according to embodiments of the present disclosure may be used for implementing the technical solution of the above method embodiments. The implementation principle and the technical effects of the apparatus are similar to the method and will not be repeated herein.

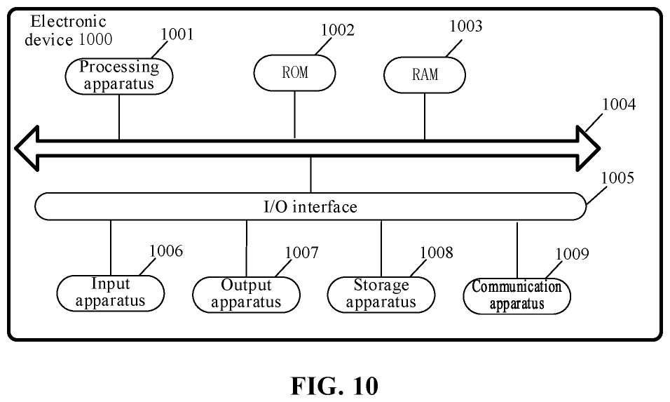

FIG. 10 illustrates a structural diagram of an electronic device provided by embodiments of the present disclosure. With reference to FIG. 10, a structural diagram of an electronic device 1000 adapted to implement embodiments of the present disclosure is shown. The electronic device 1000 may be a terminal device or a server, where the terminal device may include, but not limited to, mobile terminals, such as mobile phones, notebooks, digital broadcast receivers, Personal Digital Assistant (PDA), Portable Android Device (PAD), Portable Multimedia Player (PMP) and vehicle terminals (such as car navigation terminal) and fixed terminals, e.g., digital TVs and desktop computers etc. The electronic device shown in FIG. 10 is just an example and should not put any restrictions on the functions and application ranges of embodiments of the present disclosure.

As shown in FIG. 10, the electronic device 1000 may include a processing apparatus (e.g., a central processor, a graphic processor, or the like) 1001, which can execute various suitable actions and processing based on the programs stored in the read-only memory (ROM) 1002 or programs loaded into the random-access memory (RAM) 1003 from a storage apparatus 1008. The RAM 1003 can also store all kinds of programs and data required by the operations of the electronic device 1000. Processing apparatus 1001, ROM 1002 and RAM 1003 are connected to each other via a bus 1004. The input/output (I/O) interface 1005 is also connected to the bus 604.

Usually, the following apparatuses may connect to the I/O interface 1005: an input apparatus 1006 (including, e.g., touch screen, touchpad, keyboard, mouse, camera, microphone, accelerometer, gyroscope and like), an output apparatus 1007 (including liquid crystal display (LCD), speaker and vibrator etc.), a storage apparatus 1008 (including tape and hard disk etc.), and a communication apparatus 1009. The communication apparatus 1009 may allow the electronic device 1000 to exchange data with other devices through wired or wireless communications. Although FIG. 10 illustrates the electronic device 1000 having various apparatuses, it is to be understood that it is not a prerequisite to implement or provide all illustrated apparatuses. Alternatively, more or less apparatuses may be implemented or provided.

In particular, in accordance with embodiments of the present disclosure, the process depicted above with reference to the flowchart may be implemented as computer software programs. For example, embodiments of the present disclosure include a computer program product including computer programs carried on a computer readable medium, wherein the computer programs include program codes for executing the method demonstrated by the flowchart. In such embodiments, the computer programs may be loaded and installed from networks via the communication apparatus 1009, or installed from the storage apparatus 1008, or installed from the ROM 1002. The computer programs, when executed by the processing apparatus 1001, perform the above functions defined in the method according to embodiments of the present disclosure.

It is to be appreciated the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same.

In the present disclosure, the computer readable signal medium may include a data signal propagated in baseband or as part of a carrier wave, carrying computer readable program codes therein. Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and RF (radio frequency) etc., or any suitable combinations thereof.

The above computer readable medium may be included in the aforementioned electronic device or stand-alone without fitting into the electronic device.

The above computer-readable medium carriers one or more programs, where the one or more programs, when executed by the electronic device, cause the electronic device to perform the method shown by the above embodiments.

Computer program instructions for executing operations of the present disclosure are written in one or more programming languages or combinations thereof. The above programming languages include object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instruction for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in embodiments of the present disclosure may be implemented by software or hardware. In some cases, the name of the unit should not be considered as the restriction over the unit per se. For example, the first obtaining unit also may be described as “a unit that obtains at least two internet protocol addresses”.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable storage medium for example may include, but not limited to, electric, magnetic, optical, electromagnetic, infrared or semiconductor systems, apparatus or devices or any combinations thereof. Specific examples of the machine readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

In the first aspect, there is provided an image processing method according to one or more embodiments of the present disclosure, comprising: obtaining an image feature corresponding to a first image, the image feature including a domain feature and a class feature; performing a feature filtering processing on the domain feature in the image feature to obtain the class feature of the first image, wherein a relevance between the domain feature and an image classification of the first image is below a first threshold; and determining an image class of the first image according to the class feature.

In accordance with one or more embodiments of the present disclosure, performing the feature filtering processing on the domain feature in the image feature to obtain the class feature of the first image includes: processing the image feature according to a feature filtering layer in a first model to obtain a corresponding domain feature of the first image, the feature filtering layer in configured to obtain the domain feature in the image feature; and subtracting the domain feature from the image feature to obtain the class feature of the first image; wherein the first model is a model trained according to a plurality of groups of samples, where the plurality of groups of samples include sample images and sample classes corresponding to the sample images.

In accordance with one or more embodiments of the present disclosure, the first model includes the feature filtering layer and a first classifier, and the first model is determined by: obtaining a sample image feature and a sample class of a sample image; processing the sample image feature through the feature filtering layer to obtain a sample domain feature; determining a sample class feature according to the sample image feature and the sample domain feature; and updating parameters of the first model according to the sample domain feature, the sample class feature, the sample class and the first classifier.

In accordance with one or more embodiments of the present disclosure, updating parameters of the first model according to the sample domain feature, the sample class feature, the sample class and the first classifier includes: processing the sample domain feature by the first classifier to obtain a plurality of sample first probabilities that the sample image indicated by the sample domain feature belongs to a plurality of preset classes; processing the sample class feature by the first classifier to obtain a plurality of sample second probabilities that the sample image indicated by the sample class feature belongs to the plurality of preset classes; and updating parameters in the feature filtering layer and the first classifier according to the plurality of sample first probabilities and the plurality of sample second probabilities.

In accordance with one or more embodiments of the present disclosure, updating parameters in the feature filtering layer and the first classifier according to the plurality of sample first probabilities and the plurality of sample second probabilities includes: obtaining a first distribution probability, the first distribution probability is a uniform distribution probability; determining a first loss according to the plurality of sample first probabilities and the first distribution probability; determining a second loss according to the plurality of sample second probabilities and the sample class; and updating the parameters in the feature filtering layer and the first classifier according to the first loss and the second loss.

In accordance with one or more embodiments of the present disclosure, determining a second loss according to the plurality of sample second probabilities and the sample class includes: determining a second distribution probability according to the sample class, wherein a probability of a preset class identical to the sample class corresponds to a maximum probability in the second distribution probability; and determining the second loss according to the plurality of sample second probabilities and the second distribution probability.

In accordance with one or more embodiments of the present disclosure, the first model also includes a second classifier, and the method further comprises, after updating parameters in the feature filtering layer and the first classifier: determining a third loss according to the sample class feature and the sample class; and updating parameters of the second classifier according to the third loss.

In a second aspect, embodiments of the present disclosure provide an image processing apparatus. The image processing apparatus comprises an obtaining module, a processing module and a first determination module, wherein: the obtaining module is configured to obtain an image feature corresponding to a first image, the image feature including a domain feature and a class feature; the processing module is configured to perform a feature filtering processing on the domain feature in the image feature to obtain the class feature of the first image, wherein a relevance between the domain feature and an image classification of the first image is below a first threshold; and the first determination module is configured to determine an image class of the first image according to the class feature.

In accordance with one or more embodiments of the present disclosure, the processing module is specifically configured to: process the image feature according to a feature filtering layer in a first model to obtain a corresponding domain feature of the first image, the feature filtering layer is configured to obtain the domain feature in the image feature; and subtract the domain feature from the image feature to obtain the class feature of the first image; wherein the first model is a model trained according to a plurality of groups of samples, where the plurality of groups of samples include sample images and sample classes corresponding to the sample images.

In accordance with one or more embodiments of the present disclosure, the image processing apparatus further includes a second determination module, wherein the second determination module is configured to: obtain a sample image feature and a sample class of a sample image; process the sample image feature through the feature filtering layer to obtain a sample domain feature; determine a sample class feature according to the sample image feature and the sample domain feature; and update parameters of the first model according to the sample domain feature, the sample class feature, the sample class, and the first classifier.

In accordance with one or more embodiments of the present disclosure, the second determination module is specifically configured to: process the sample domain feature by the first classifier to obtain a plurality of sample first probabilities that the sample image indicated by the sample domain feature belongs to a plurality of preset classes; process the sample class feature by the first classifier to obtain a plurality of sample second probabilities that the sample image indicated by the sample class feature belongs to the plurality of preset classes; and update parameters in the feature filtering layer and the first classifier according to the plurality of sample first probabilities and the plurality of sample second probabilities.

In accordance with one or more embodiments of the present disclosure, the second determination module is specifically configured to: obtain a first distribution probability, the first distribution probability is a uniform distribution probability; determine a first loss according to the plurality of sample first probabilities and the first distribution probability; determine a second loss according to the plurality of sample second probabilities and the sample class; and update parameters in the feature filtering layer and the first classifier according to the first loss and the second loss.

In accordance with one or more embodiments of the present disclosure, the second determination module is specifically configured to: determine a second distribution probability according to the sample class, wherein a probability of a preset class identical to the sample class corresponds to a maximum probability in the second distribution probability; and determine the second loss according to the plurality of sample second probabilities and the second distribution probability.

In accordance with one or more embodiments of the present disclosure, the second determination module is specifically configured to: determine a third loss according to the sample class feature and the sample class; and update parameters of the second classifier according to the third loss.

In a third aspect, embodiments of the present disclosure provide an electronic device, comprising: a processor and a memory; where the memory stores computer-executable instructions; the processor executes the computer-executable instructions stored in the memory, such that the at least one processor performs the image processing method according to the above first aspect and various implementations of the above first aspect.

In a fourth aspect, embodiments of the present disclosure provide a computer-readable storage medium, the computer-readable storage medium is stored with computer-executable instructions, which computer-executable instructions, when executed by a processor, implement the image processing method according to the above first aspect and various implementations of the above first aspect.

In a fifth aspect, embodiments of the present disclosure provide a computer program product including computer programs, which computer programs, when executed by the processor, implement the image processing method according to the above first aspect and various implementations of the above first aspect.

It is to be noted that the terms “one” and “more” disclosed in the present disclosure are exemplary rather than restrictive. Those skilled in the art should understand that the above terms are to be read as “one or more” unless indicated otherwise in the context.

Names of the messages or information exchanged between a plurality of apparatuses in the implementations of the present disclosure are provided only for explanatory purpose, rather than restricting the scope of the messages or information.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

It is to be understood that data involved in the technical solution should comply with corresponding laws and regulations. Data may include information, parameters and messages etc., such as traffic switching indication information.

The above description only explains the preferred embodiments of the present disclosure and the technical principles applied. Those skilled in the art should understand that the scope of the present disclosure is not limited to the technical solution resulted from particular combinations of the above technical features, and meanwhile should also encompass other technical solutions formed from any combinations of the above technical features or equivalent features without deviating from the above disclosed inventive concept, such as the technical solutions formed by substituting the above features with the technical features disclosed here with similar functions.

Furthermore, although the respective operations are depicted in a particular order, it should be appreciated that the operations are not required to be completed in the particular order or in succession. In some cases, multitasking or multiprocessing is also beneficial. Likewise, although the above discussion comprises some particular implementation details, they should not be interpreted as limitations over the scope of the present disclosure. Some features described separately in the context of embodiments of the description can also be integrated and implemented in a single embodiment. Conversely, all kinds of features described in the context of a single embodiment can also be separately implemented in multiple embodiments or any suitable sub-combinations.

Although the subject matter is already described by languages specific to structural features and/or method logic acts, it is to be appreciated that the subject matter defined in the attached claims is not limited to the above described particular features or acts. On the contrary, the above described particular features and acts are only example forms for implementing the claims.

I/We claim:

1. An image processing method comprising:
obtaining an image feature corresponding to a first image, the image feature comprising a domain feature and a class feature;
performing a feature filtering processing on the domain feature in the image feature to obtain the class feature of the first image, wherein a relevance between the domain feature and an image classification of the first image is below a first threshold; and
determining an image class of the first image according to the class feature.

2. The method of claim 1, wherein performing the feature filtering processing on the domain feature in the image feature to obtain the class feature of the first image comprises:
processing the image feature according to a feature filtering layer in a first model to obtain a corresponding domain feature of the first image, wherein the feature filtering layer is configured to obtain the domain feature in the image feature; and
subtracting the domain feature from the image feature to obtain the class feature of the first image;
wherein the first model is a model trained according to a plurality of groups of samples, where the plurality of groups of samples comprise sample images and sample classes corresponding to the sample images.

3. The method of claim 2, wherein the first model comprises the feature filtering layer and a first classifier, and wherein the first model is determined by:
obtaining a sample image feature and a sample class of a sample image;
processing the sample image feature through the feature filtering layer to obtain a sample domain feature;
determining a sample class feature according to the sample image feature and the sample domain feature; and
updating parameters of the first model according to the sample domain feature, the sample class feature, the sample class, and the first classifier.

4. The method of claim 3, wherein updating parameters of the first model according to the sample domain feature, the sample class feature, the sample class, and the first classifier comprises:
processing the sample domain feature by the first classifier to obtain a plurality of sample first probabilities that the sample image indicated by the sample domain feature belongs to a plurality of preset classes;
processing the sample class feature by the first classifier to obtain a plurality of sample second probabilities that the sample image indicated by the sample class feature belongs to the plurality of preset classes; and
updating parameters in the feature filtering layer and the first classifier according to the plurality of sample first probabilities and the plurality of sample second probabilities.

5. The method of claim 4, wherein updating the parameters in the feature filtering layer and the first classifier according to the plurality of sample first probabilities and the plurality of sample second probabilities comprises:
obtaining a first distribution probability, the first distribution probability is a uniform distribution probability;
determining a first loss according to the plurality of sample first probabilities and the first distribution probability;
determining a second loss according to the plurality of sample second probabilities and the sample class; and
updating the parameters in the feature filtering layer and the first classifier according to the first loss and the second loss.

6. The method of claim 5, wherein determining the second loss according to the plurality of sample second probabilities and the sample class comprises:
determining a second distribution probability according to the sample class, a probability of a preset class identical to the sample class corresponds to a maximum probability in the second distribution probability; and
determining the second loss according to the plurality of sample second probabilities and the second distribution probability.

7. The method of claim 3, wherein the first model further comprises a second classifier, and wherein the method further comprises, after updating the parameters in the feature filtering layer and the first classifier:
determining a third loss according to the sample class feature and the sample class; and
updating parameters of the second classifier according to the third loss.

8. An electronic device comprising a processor and a memory;
wherein the memory stores computer-executable instructions;
the processor executes the computer-executable instructions stored in the memory, and the processor is caused to:
obtain an image feature corresponding to a first image, the image feature comprising a domain feature and a class feature;
perform a feature filtering processing on the domain feature in the image feature to obtain the class feature of the first image, wherein a relevance between the domain feature and an image classification of the first image is below a first threshold; and
determine an image class of the first image according to the class feature.

9. The electronic device of claim 8, wherein the processor is caused to perform the feature filtering processing by:
processing the image feature according to a feature filtering layer in a first model to obtain a corresponding domain feature of the first image, wherein the feature filtering layer is configured to obtain the domain feature in the image feature; and
subtracting the domain feature from the image feature to obtain the class feature of the first image;
wherein the first model is a model trained according to a plurality of groups of samples, where the plurality of groups of samples comprise sample images and sample classes corresponding to the sample images.

10. The electronic device of claim 9, wherein the first model comprises the feature filtering layer and a first classifier, and wherein the first model is determined by:
obtaining a sample image feature and a sample class of a sample image;
processing the sample image feature through the feature filtering layer to obtain a sample domain feature;
determining a sample class feature according to the sample image feature and the sample domain feature; and
updating parameters of the first model according to the sample domain feature, the sample class feature, the sample class, and the first classifier.

11. The electronic device of claim 10, wherein the processor is caused to update parameters of the first model by:
processing the sample domain feature by the first classifier to obtain a plurality of sample first probabilities that the sample image indicated by the sample domain feature belongs to a plurality of preset classes;
processing the sample class feature by the first classifier to obtain a plurality of sample second probabilities that the sample image indicated by the sample class feature belongs to the plurality of preset classes; and
updating parameters in the feature filtering layer and the first classifier according to the plurality of sample first probabilities and the plurality of sample second probabilities.

12. The electronic device of claim 11, wherein the processor is caused to update the parameters in the feature filtering layer and the first classifier by:
obtaining a first distribution probability, the first distribution probability is a uniform distribution probability;
determining a first loss according to the plurality of sample first probabilities and the first distribution probability;
determining a second loss according to the plurality of sample second probabilities and the sample class; and
updating the parameters in the feature filtering layer and the first classifier according to the first loss and the second loss.

13. The electronic device of claim 12, wherein the processor is caused to determine the second loss by:
determining a second distribution probability according to the sample class, a probability of a preset class identical to the sample class corresponds to a maximum probability in the second distribution probability; and
determining the second loss according to the plurality of sample second probabilities and the second distribution probability.

14. The electronic device of claim 10, wherein the first model further comprises a second classifier, and wherein the processor is further caused to, after updating the parameters in the feature filtering layer and the first classifier:
determine a third loss according to the sample class feature and the sample class; and
update parameters of the second classifier according to the third loss.

15. A computer-readable storage medium, storing computer-executable instructions, which, when executed by a processor, implement operations comprising:
obtaining an image feature corresponding to a first image, the image feature comprising a domain feature and a class feature;
performing a feature filtering processing on the domain feature in the image feature to obtain the class feature of the first image, wherein a relevance between the domain feature and an image classification of the first image is below a first threshold; and
determining an image class of the first image according to the class feature.

16. The computer-readable storage medium of claim 15, wherein the operations comprise:
processing the image feature according to a feature filtering layer in a first model to obtain a corresponding domain feature of the first image, wherein the feature filtering layer is configured to obtain the domain feature in the image feature; and
subtracting the domain feature from the image feature to obtain the class feature of the first image;
wherein the first model is a model trained according to a plurality of groups of samples, where the plurality of groups of samples comprise sample images and sample classes corresponding to the sample images.

17. The computer-readable storage medium of claim 16, wherein the first model comprises the feature filtering layer and a first classifier, and wherein the first model is determined by:
obtaining a sample image feature and a sample class of a sample image;
processing the sample image feature through the feature filtering layer to obtain a sample domain feature;
determining a sample class feature according to the sample image feature and the sample domain feature; and
updating parameters of the first model according to the sample domain feature, the sample class feature, the sample class, and the first classifier.

18. The computer-readable storage medium of claim 17, wherein the operations comprise:
processing the sample domain feature by the first classifier to obtain a plurality of sample first probabilities that the sample image indicated by the sample domain feature belongs to a plurality of preset classes;
processing the sample class feature by the first classifier to obtain a plurality of sample second probabilities that the sample image indicated by the sample class feature belongs to the plurality of preset classes; and
updating parameters in the feature filtering layer and the first classifier according to the plurality of sample first probabilities and the plurality of sample second probabilities.

19. The computer-readable storage medium of claim 18, wherein the operations comprise:
obtaining a first distribution probability, the first distribution probability is a uniform distribution probability;
determining a first loss according to the plurality of sample first probabilities and the first distribution probability;
determining a second loss according to the plurality of sample second probabilities and the sample class; and
updating the parameters in the feature filtering layer and the first classifier according to the first loss and the second loss.

20. The computer-readable storage medium of claim 17, wherein the first model further comprises a second classifier, and wherein the operations comprise: after updating the parameters in the feature filtering layer and the first classifier:
determining a third loss according to the sample class feature and the sample class; and
updating parameters of the second classifier according to the third loss.
